(19) United States
(12) Patent Application Publication
(10) Pub. No.: US 2006/0093335 A1
(43) Pub. Date: May 4, 2006

(54) Recording medium, and method and apparatus for reproducing data from the recording medium

(76) Inventors: Byung Jin Kim, Seongnam-si (KR); Jea Yong Yoo, Seoul (KR); Kang Soo Seo, Anyang-si (KR)

Correspondence Address: HARNESS, DICKEY & PIERCE, P.L.C., P.O. BOX 8910, RESTON, VA, 20195, US

(21) Appl. No.: 11/262,838

(22) Filed: Nov. 1, 2005

(30) Foreign Application Priority Data
Nov. 2, 2004 (KR) 10-2004-0088390

(51) Int. Cl. H04N 5/76

(52) U.S. Cl. 386/111; 386/112

(57) ABSTRACT

A recording medium, and a method and apparatus for reproducing data from the recording medium are disclosed. The recording medium includes a first area for recording a stream including a plurality of Groups Of Pictures (GOPs); and a second area for recording GOP type information (GOP_type) classified according to GOP lengths. Therefore, a data stream recorded in the recording medium can be effectively reproduced, resulting in greater convenience of use.

This application claims the benefit of Korean Patent Application No.10-2004-0088390, filed on Nov. 2, 2004, which is hereby incorporated by reference as if fully set forth herein.

### BACKGROUND OF THE INVENTION

1. Field of the Invention

The present invention relates to a recording medium, and a method and apparatus for recording/reproducing data in/from a recording medium.

2. Discussion of the Related Art

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

When data is recorded in the recording medium, various coding techniques are widely adapted to compress the data, for example, a data coding method called a Moving Picture Experts Group (MPEG) technique. In association with the above-mentioned description, a Group Of Picture (GOP) concept has been introduced to various data coding standards including the aforementioned MPEG technique, such that the GOP acts as a single coding unit for dividing a picture of a single screen into a plurality of picture units.

However, although different-sized GOPs must be recorded according to recording environments so as to record a data stream composed of several GOPs in the recording medium, a preferable recording medium file structure and a method for reproducing data of a recording medium to implement the aforementioned recording of the aforementioned different-sized GOPs are not yet well known to those skilled in the art, such that many limitations and problems occur in developing a BD-based optical recording/reproducing device.

### SUMMARY OF THE INVENTION

Accordingly, the present invention is directed to a recording medium, and a method and apparatus for reproducing data from the recording medium that substantially obviate one or more problems due to limitations and disadvantages of the related art.

An object of the present invention is to provide an improved record/reproduction method suitable for a recording medium, and an apparatus for use in the improved record/reproduction method.

Another object of the present invention is to provide a method and apparatus for reproducing data of a recording medium, such that specific information for identifying GOP types of a stream and type information of a stream composed of different GOPs is recorded in the recording medium.

Still another object of the present invention is to provide a method and apparatus for reproducing data of the recording medium, such that picture type identification (ID) information of individual GOPs contained in a stream is recorded in the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium comprises: a first area for recording a stream including a plurality of Groups Of Pictures (GOPs); and a second area for recording GOP type information (GOP_type) classified according to GOP lengths.

In another aspect of the present invention, there is provided a method for reproducing data of a recording medium in which a plurality of Groups Of Pictures (GOPs) are recorded, comprising the steps of: a) reading first information (GOP_type) for designating GOP types from the recording medium; and b) reproducing individual GOPs contained in the recording medium using the read first information (GOP_type).

In yet another aspect of the present invention, there is provided a method for recording data in a recording medium in which a data stream composed of a plurality of Groups Of Pictures (GOPs) is recorded, comprising the steps of: a) classifying the GOPs recorded in the recording medium into at least one GOP type according to GOP lengths; and b) simultaneously recording the classified GOPs and GOP type information for designating GOP types in the recording medium.

In yet another aspect of the present invention, there is provided an apparatus for reproducing data of a recording medium in which a plurality of Groups Of Pictures (GOPs) are recorded, comprising: a recording/reproducing unit for reading Groups Of Pictures (GOPs) and GOP type information (GOP_type) for designating types of the GOPs from the recording medium; a decoder for reproducing individual GOPs contained in the recording medium using the read GOP type information (GOP_type); and a controller for controlling operations of the recording/reproducing unit and the decoder.

In yet another aspect of the present invention, there is provided an apparatus for recording data in a recording medium in which a data stream composed of a plurality of Groups Of Pictures (GOPs) is recorded, comprising: an encoder for classifying the recorded GOPs into at least one GOP type according to GOP lengths, and coding the stream composed of the classified GOPs; a recording/reproducing unit for recording the stream composed of the classified GOPs and GOP type information (GOP_type) capable of designating GOP types in the recording medium; and a controller for controlling operations of the recording/reproducing unit and the encoder.

In yet another aspect of the present invention, there is provided a recording medium comprising: a first area for recording a stream including a plurality of Groups Of Pictures (GOPs), and a second area for recording map information designating types of individual pictures contained in each GOP.

In yet another aspect of the present invention, there is provided a method for recording data in a recording medium in which a plurality of Groups Of Pictures (GOPs) are recorded, comprising the steps of: a) reading map information for designating types of individual pictures contained in each GOP from the recording medium; and b) decoding individual pictures contained in the GOP using the read map information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a relationship between a recording medium and an optical recording/reproducing device for recording/reproducing data in/from the recording medium according to the present invention;

FIG. 2 is a conceptual diagram illustrating a file structure recorded in an optical disc acting as a recording medium according to the present invention;

FIG. 3 is a structural diagram illustrating a data record area recorded in an optical disc according to the present invention;

FIGS. 4A-4C show GOP types contained in a data stream and types of a stream equipped with the GOP types according to the present invention;

FIGS. 5A-5B show first information (GOP_type) for identifying individual GOP types and second information (stream_type) for identifying stream types, wherein each of the first information and the second information is configured in the form of a table, according to the present invention;

FIG. 5C shows map information (GOP_structure_map) for identifying individual pictures contained in a GOP according to the present invention;

FIG. 6 is a conceptual diagram illustrating an information record process during which GOP-associated information is recorded in a file structure of an optical disc according to the present invention; and

FIG. 7 is a block diagram illustrating an optical recording/reproducing device according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

A recording medium, and a method and apparatus for recording/reproducing data in/from the recording medium will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all recordable mediums capable of storing data therein, for example, an optical disc, and a magnetic tape, etc., according to various recording schemes. For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

The term “GOP” is indicative of a data unit for processing a plurality of pictures contained in a single screen in a single group, and is indicative of one of coding layers introduced for a random access process, etc. In association with the above-mentioned description, although the present invention will use the GOP for use in an MPEG coding scheme as an example, it is well known to those skilled in the art that the scope and spirit of the present invention is not limited to only the MPEG-coded GOP, and is also applicable to another coding scheme based on the same concept as that of the MPEG-coded GOP.

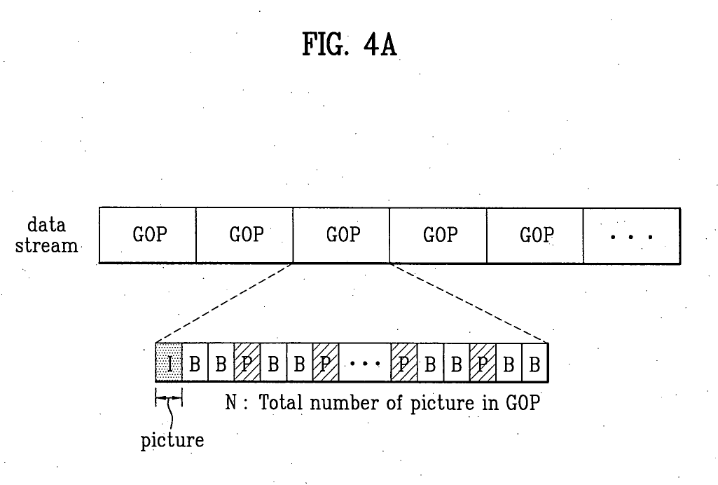

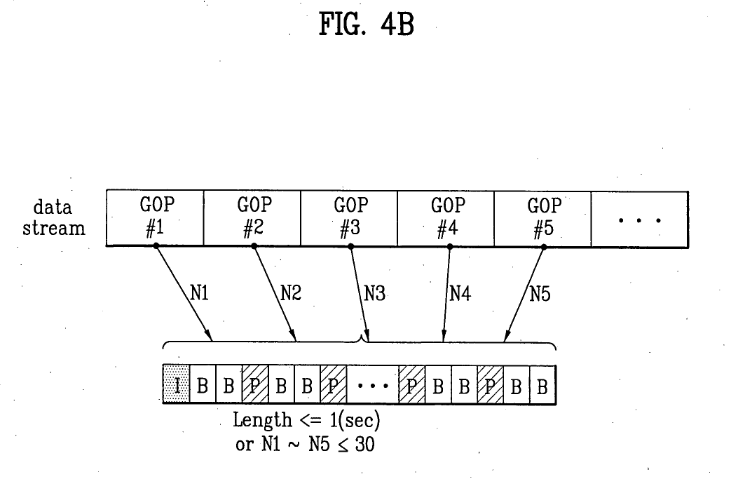

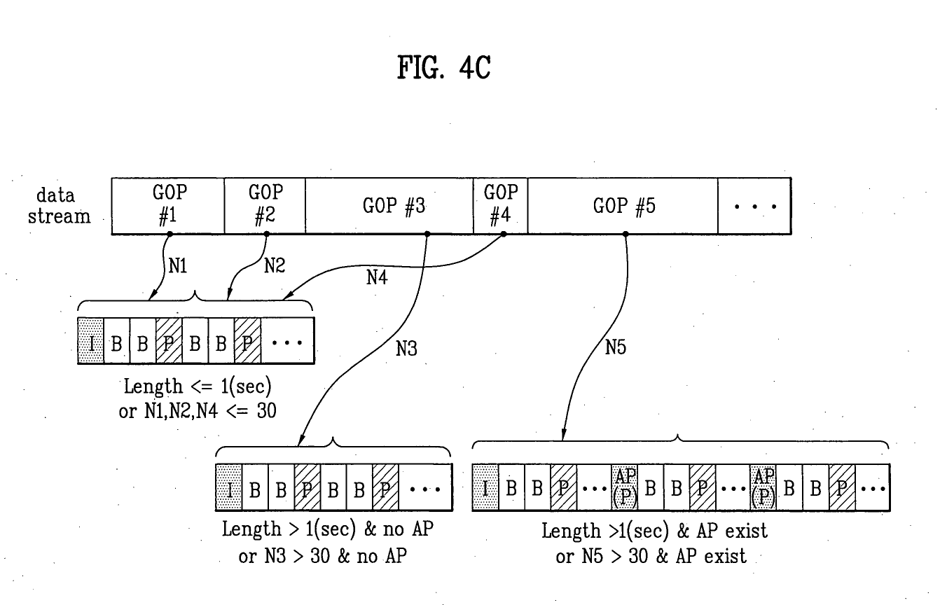

In association with the above-mentioned description, the present invention aims to classify the GOP into a plurality of GOP types according to GOP lengths. Specifically, if the length of a specific GOP is less than a specific reference value, the specific GOP is referred to as a “Normal GOP”. Otherwise, if the length of a specific GOP is equal to or higher than the specific reference value, the specific GOP is referred to as a “Long GOP”. A detailed description of the GOP will be given with reference to drawings from FIG. 4a.

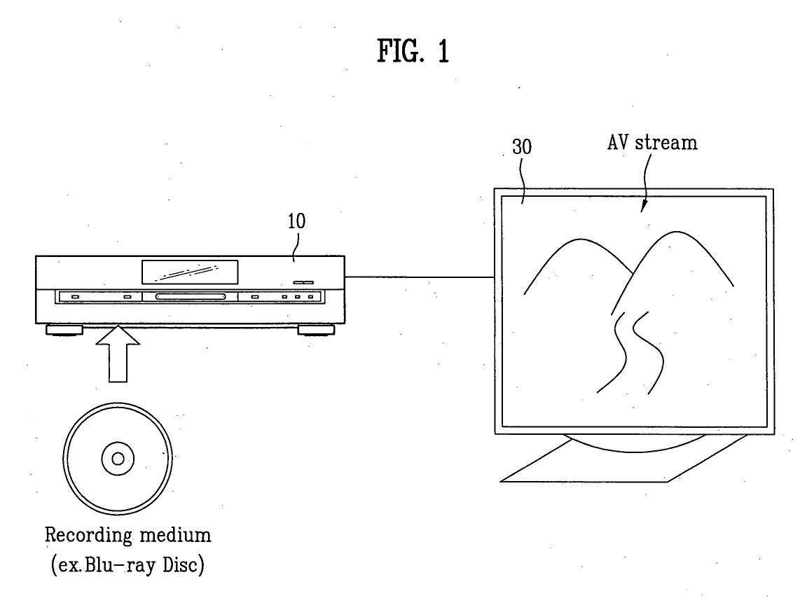

FIG. 1 is a conceptual diagram illustrating individual titles recorded in a recording medium according to the present invention. In more detail, FIG. 1 shows an example of a BD for use in an optical recording/reproducing device 10.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention uses a BD-player capable of performing only a reproduction operation or a BD-recorder capable of performing record/reproduction operations as a preferred embodiment for the convenience of description. It is well known in the art that the optical recording/reproducing device 10 is also applicable to a drive embedded in a specific device such as a computer.

The optical recording/reproducing device 10 records/reproduces data in/from the BD, reads data from the BD, performs a signal process and a decoding process on the read data according to attribute information of the read data, and transmits the signal processed result and the decoding result to a display 30 connected to the optical recording/reproducing device 10, such that a user can view the signal processed result and the decoding result on the display 30.

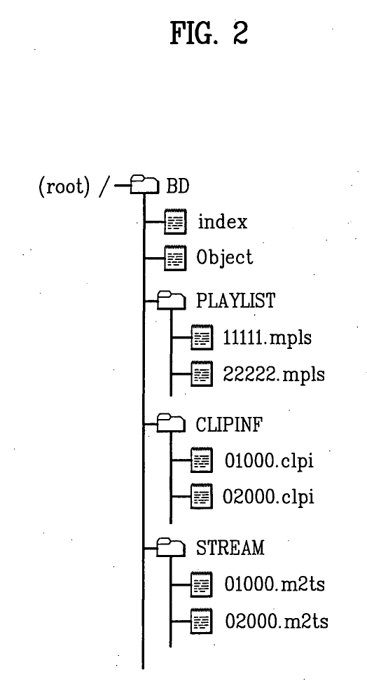

FIG. 2 is a conceptual diagram illustrating a file structure recorded in a recording medium, for example, an optical disc such as a BD.

The disc file structure according to the present invention includes one or more BD directories in a single root directory. The BD directory includes not only an index file “index” acting as a general file (i.e., an upper file) capable of guaranteeing user interactivity, but also the above-mentioned object. The reproduction/management file structure includes a variety of directories for storing information of actual data recorded in a disc and other information associated with a method for reproducing the data, for example, a playlist directory (PLAYLIST), a clip information directory (CLIPINF), a stream directory (STREAM), and a java directory (JAVA). The above-mentioned directories and a variety of files included in the directory will hereinafter be described.

The stream directory (STREAM) includes a plurality of AV (Audio and Video) stream files recorded in a disc according to a specific format. For example, the stream directory (STREAM) uses extension names of stream files (01000.m2 ts and 02000.m2 ts) as a specific extension name “*.m2ts”. Generally, the stream file records moving image data, and acts as a file where a data stream including the GOP is recorded.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) record attribute information and timing information of the stream files therein. The clip-info files (*.clpi) connected to the stream files (*.m2ts) on a one-to-one basis are generically named a “Clip”. In other words, this means that a single stream file (*.m2ts) must correspond to a clip-info file (*.clpi).

The playlist directory (PLAYLIST) includes a plurality of playlist files (*.mpls). Each playlist file (*.mpls) includes one or more playitems (PlayItem) for designating a playback interval during which a specific clip is reproduced. The playitem (PlayItem) includes information associated with a specific clip to be reproduced, i.e., information associated with a reproduction start time (IN-Time) and other information associated with a reproduction termination time (OUT-Time) of a clip determined to be a clip name (Clip_Information_File_name) contained in the playitem (PlayItem).

The playlist file (*.mpls) is used as a basic reproduction/management file unit contained in an overall reproduction/management file structure, such that it can reproduce a desired clip using a combination of one or more playitems. The playlist file (*.mpls) may include data different from reproduction data formed by the playitem. Particularly, the playlist file (*.mpls) may include a sub-playitem (SubPlayItem) for reproducing auxiliary data.

The index file (index) includes title information and menu information recorded in a corresponding disc, and controls a specific stream contained in a user-desired disc to be reproduced using user interactivity. The object file (Object) is indicative of a set of commands for connecting the index file (index) to the playlist file (*.mpls), and acts a file in which a scenario for reproducing disc data is recorded.

In association with the above-mentioned description, only the index file (index) can be recognized by the user. The remaining files other than the index file (index), i.e., the object file, the playlist directory (PLAYLIST), the clip-info directory (CLIPINF), and the stream directory (STREAM), cannot be recognized the user, and are configured according to a playback or reproduction scenario of a disc author.

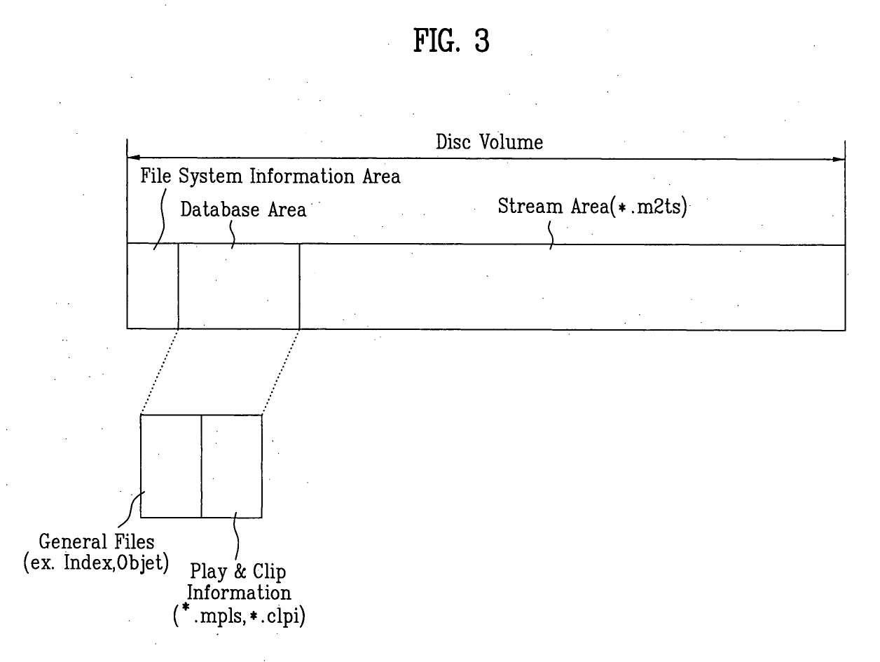

FIG. 3 is a structural diagram illustrating an exemplary disc structure for recording information associated with the file structure in a disc.

As shown in FIG. 3, from the viewpoint of an inner area of the disc, the above-mentioned disc structure sequentially includes a file system information area serving as system information for managing all files, a database area for recording a playlist file and a clip-info file to reproduce a recorded stream (*.m2ts), and a stream area for recording a plurality of streams composed of audio data, video data, and graphic data, etc. Particularly, it should be noted that data recorded in the stream area of the disc may be determined to be a data stream having the GOP. However, individual areas contained in the disc are exemplarily used, and it is well known to those skilled in the art that the present invention is not always limited to an arrangement structure of individual areas shown in FIG. 3.

FIGS. 4A˜4C show GOP types contained in a data stream and types of a stream equipped with the GOP types according to the present invention. In more detail, FIGS. 4A˜4C show data streams, each of which includes GOPs, according to the present invention, and stream types according to GOP lengths.

FIG. 4A is a structural diagram illustrating a general GOP structure according to the present invention.

In association with the above-mentioned description, the GOP according to the present invention includes a variety of picture types, for example, an Intra (I) picture, a Predictive (P) picture, and a Bi-directional (B) picture. The I-picture, the P-picture, and the B-picture will hereinafter be described.

The I-picture is equal to an intra-picture, and indicates a specific case in which all data units contained in a screen are coded without being predicted. The I-picture is used as a reference picture during a predictive coding process of other pictures (i.e., B and P pictures). Therefore, the I-picture includes a large amount of data as compared to other pictures, and configures a single complete screen without being affected by the above other pictures, such that it is basically used when a random access operation or a trick play operation is performed in the GOP. Typically, a single I-picture may be present in the GOP, or a plurality of I-pictures may be present in the GOP as necessary.

The P-picture is equal to a forward predictive picture, and is indicative of a predictive-coded picture based on the I-picture or a previous P-picture. Therefore, the P-picture must be decoded along with the aforementioned I-picture or the previous P-picture, such that it can construct a correct screen.

The B-picture is equal to a bi-directional picture, and is indicative of a bi-directional predictive-coded picture based on the I-picture and/or P-picture. Therefore, the B-picture must be decoded along with the I-picture and/or the P-picture, such that it can construct a correct screen.

A single GOP is composed of the I-picture, the P-picture, and the B-picture. The total number (i.e., N) of all pictures contained in the GOP is given as additional information. In other words, the value of N indicates GOP length information. Generally, if the value of N is set to 15 as denoted by N=15, a decoding time of about 0.5 second is consumed. If the value of N is set to 30 as denoted by N=30, a decoding time of about 1 second is consumed.

FIGS. 4B˜4C show data streams including GOPs according to the present invention. Specifically, FIGS. 4B˜4C show data streams, each of which includes the normal GOP and/or the long GOP.

In association with the above-mentioned description, as previously stated above, the normal GOP is indicative of a GOP, the length of which is less than a specific reference value, and the long GOP is indicative of a GOP, the length of which is equal to or higher than the specific reference value. The above-mentioned specific reference may be determined according to the following conditions.

Generally, if the number N of all pictures contained in the GOP is high, a data amount of all data streams is reduced whereas a time consumed for decoding a corresponding GOP is increased. For example, the comparison of a first case in which a data stream composed of 120 pictures is composed of 4 GOPs denoted by N=30with a second case in which a data stream composed of 120 pictures is composed of 1 GOP denoted by N=120 is as follows.

According to the aforementioned first case, a data stream is composed of 4 GOPs denoted by N=30, and at least one I-picture is included in individual GOPs, such that a high-quality screen image can be configured even though an amount of overall data is increased.

According to the aforementioned second case, a data stream is composed of 1 GOP denoted by N=120, and most parts of a single GOP are composed of predictive coding pictures, i.e., B-pictures and P-pictures, such that an amount of overall data is reduced but an image quality is lower than that of the first case denoted by N=30.

Therefore, various GOP types can be classified according to the total number N of pictures in GOP. For example, the GOP denoted by N<=30 having a presentation time of about 1 second or less is determined to be a normal GOP, and the other GOP denoted by N>30 having a presentation time of about 1 second or over is determined to be a long GOP.

When constructing a data stream in consideration of record environments of the data stream, the data stream is mainly composed of the normal GOP under a high transfer rate environment (e.g., 400 Mbps) at which a large amount of data can be transferred to a destination, and the data stream is mainly composed of a low transfer rate environment (e.g., 15 Mbps or less) at which a small amount of data can be transferred to a destination.

Specifically, the optical recording/reproducing device 10 for recording/reproducing data in/from the optical disc can correspond to the aforementioned high transfer rate environment (e.g., 40 Mbps) and the aforementioned low transfer rate environment (e.g., 15 Mbps or less). Therefore, when recording a data stream in the disc, the optical recording/reproducing device 10 must classify GOPs associated with the data stream, and must record the resultant data stream in the disc.

FIG. 4B shows a data stream including GOPs according to the present invention. Specifically, FIG. 4B shows a data stream composed only of normal GOPs.

Referring to FIG. 4B, all GOPs contained in the data stream are indicative of normal GOPs. Individual normal GOPs correspond to a specific case in which a total number (N) of pictures contained in the GOP is denoted by N<=30, and a predicted presentation time is equal to or less than 1 second.

FIG. 4C shows a data stream including GOPs according to the present invention. Specifically, FIG. 4C shows a data stream composed of normal GOPs and long GOPs.

Referring to FIG. 4C, a first GOP #1, a second GOP #2, and a fourth GOP #4 from among all GOPs contained in the data stream are indicative of normal GOPs, respectively. Individual normal GOPs correspond to a specific case in which a total number (N) of pictures contained in the GOP is denoted by N<=30, and a predicted presentation time is equal to or less than 1 second. Also, a third GOP #3 and a fifth GOP #4 from among all GOPs contained in the data stream are indicative of long GOPs, respectively. Individual normal GOPs correspond to a specific case in which a total number (N) of pictures contained in the GOP is denoted by N>30, and a predicted presentation time is longer than 1 second.

In association with the above-mentioned description, the aforementioned long GOPs can be classified into two long GOP types, and a detailed description thereof will hereinafter be described.

In more detail, the long GOP includes several P- and B-pictures in a corresponding long GOP. If the length of the long GOP is too long (i.e., a very long GOP), there is no reference picture in the very long GOP except for a head I-picture (also called a front I-picture), resulting in a disadvantageous random access. Generally, the I-picture acts as a head or front picture of the GOP.

Therefore, the very long GOP is classified into a first long GOP having an Access point Picture (AP) and a second long GOP having no AP. As can be seen from FIG. 4C, the long GOP #3 is equal to the second long GOP having no AP, and the long GOP #5 is equal to the first long GOP having the AP.

For another example, the long GOP may be composed of only the second long GOP having no AP, and may also be composed of only the first long GOP having the AP. Generally, if the total number (N) of pictures in the long GOP is denoted by N>60, the long GOP may include the AP as necessary.

In association with the above-mentioned description, the AP is preferably composed of the P-picture except for the front I picture. Preferably, an interval between APs is determined to be the length of the aforementioned normal GOP.

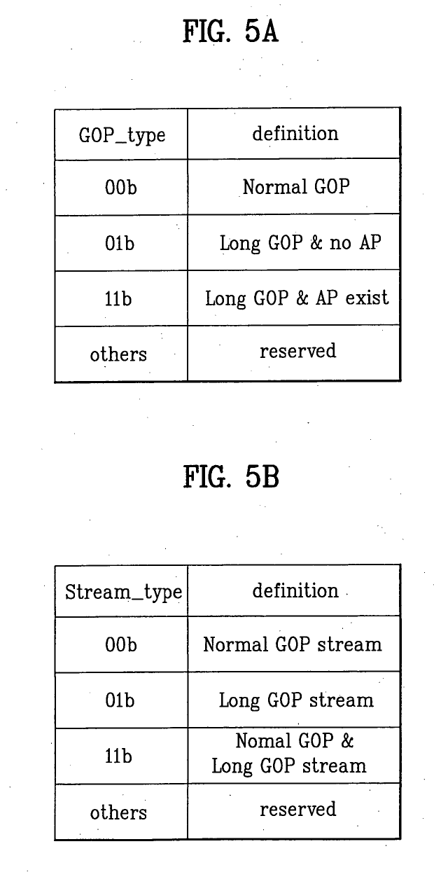

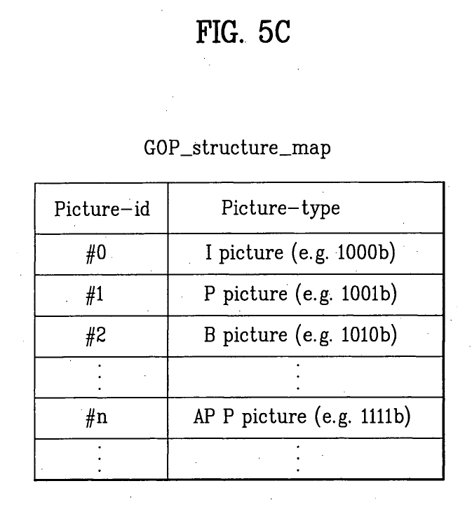

FIGS. 5A˜5B show first information (GOP_type) for identifying individual GOP types and second information (stream_type) for identifying stream types, wherein each of the first information and the second information is configured in the form of a table, according to the present invention. FIG. 5C shows map information (GOP_structure_map) for identifying individual pictures contained in a GOP according to the present invention.

In association with the above-mentioned description, FIG. 5A shows the first information (GOP_type) for identifying individual GOP types according to the present invention. As stated above, the GOPs according to the present invention are classified into a normal GOP and a long GOP, and a detailed description thereof will hereinafter be described.

In more detail, if GOP type information (GOP_type) of a specific GOP is set to “00b” as denoted by “GOP_type=00b”, it is assumed that the specific GOP is indicative of a normal GOP. If GOP type information (GOP_type) of a specific GOP is set to “01b” as denoted by “GOP_type=01b”, it is assumed that the specific GOP is indicative of a long GOP having no AP. If GOP type information (GOP_type) of a specific GOP is set to “11b” as denoted by “GOP_type=11b”, it is assumed that the specific GOP is indicative of a long GOP having an AP.

In association with the above-mentioned description, FIG. 5B shows the second information (stream_type) for identifying individual types of streams including GOPs, wherein the second information (stream_type) is configured in the form of a table. A detailed description thereof will hereinafter be given.

In more detail, if stream type information (stream_type) of a specific GOP is set to “00b” as denoted by “stream_type=00b”, it is assumed that the specific GOP is indicative of a stream composed of only a normal GOP (i.e., a normal GOP stream). If stream type information (stream_type) of a specific GOP is set to “01b” as denoted by “stream_type=01b”, it is assumed that the specific GOP is indicative of a long GOP stream. If stream type information (stream_type) of a specific GOP is set to “11b” as denoted by “stream_type=11b”, it is assumed that the specific GOP is indicative of a mixed stream of the normal GOP and the long GOP.

In association with the above-mentioned description, the aforementioned second information (stream_type) for identifying stream types can be more finely classified. For example, according to the presence or absence of the AP within the long GOP, a stream composed of only a long GOP having the AP may be defined, or the other stream composed of only a long GOP having no AP may be defined as necessary.

In association with the above-mentioned description, FIG. 5C shows map information (GOP_structure_map) for identifying individual pictures contained in a GOP according to the present invention. A detailed description of the map information (GOP_structure_map) will hereinafter be described with reference to FIG. 5C.

As can be seen from FIG. 5C, individual picture type information units acting as map information are included in individual pictures contained in a single GOP, respectively. The aforementioned map information is referred to as “GOP_structure_map” information, and provides a variety of picture types contained in the GOP. Individual types of all pictures contained in a single GOP can be identified by the aforementioned “GOP_structure_map” information, such that types of the aforementioned GOPs can also be recognized.

For example, if the picture type value of a specific picture is set to “1000b”, the specific picture is indicative of the I-picture. If the picture type value of a specific picture is set to “1000b”, the specific picture is indicative of the P-picture. If the picture type value of a specific picture is set to “1010b”, the specific picture is indicative of the B-picture. If the picture type value of a specific picture is set to “1111b”, the specific picture is indicative of the AP (Access pointer) P-picture contained in the long GOP.

Referring to FIG. 5C, for example, a first picture (picture_id=#0) from among a plurality of pictures contained in a specific GOP is indicative of the I-picture, a second picture (picture_id=#1) is indicative of the P-picture, a third picture (picture_id=#2) is indicative of the B-picture, and a (N+1)-th picture (picture_id=#n) is indicative of the AP P-picture. According to the aforementioned example of FIG. 5C, the GOP of FIG. 5C corresponds to a long GOP including at least one AP P-picture.

Preferably, the “GOP_structure_map” information may be included in a header contained in each GOP.

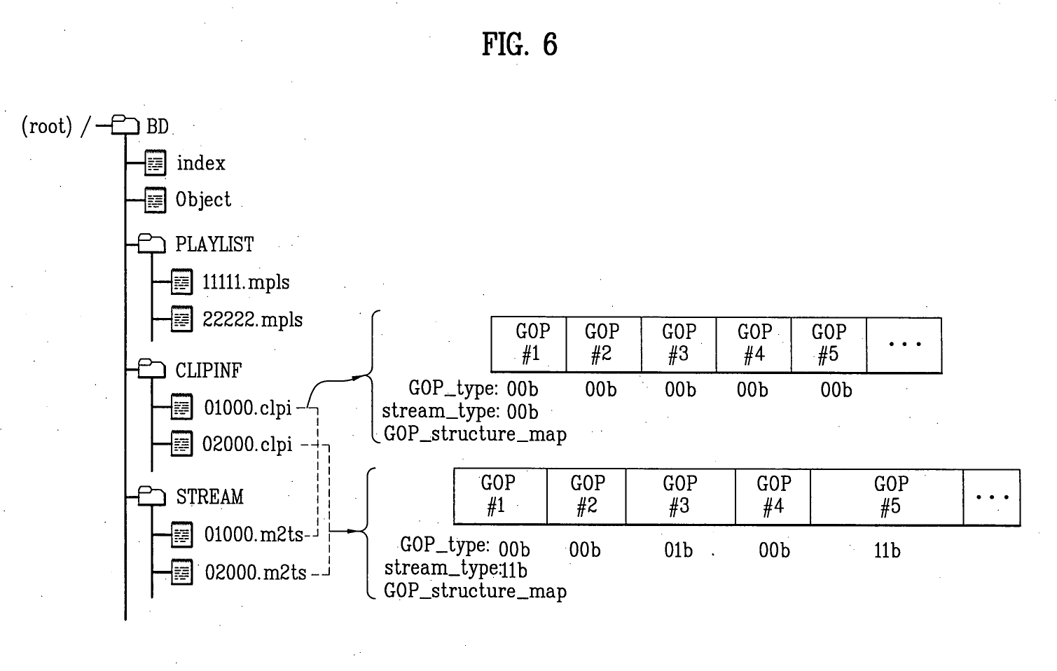

FIG. 6 shows a variety of information units, for example, a data stream including GOPs, the first information (GOP_type) for identifying GOP types, the second information (stream_type) for identifying stream types, and the “GOP_structure_map” information, and shows a method for recording the aforementioned information units in a disc file structure (i.e., a disc package). For reference, a detailed description of the file structure shown in FIG. 6C is equal to that of FIG. 2, such that it will herein be omitted for the convenience of description.

In more detail, the data stream including the GOPs is recorded in a stream file (*.m2ts) of the file structure, the “GOP_type” information for identifying GOP types is recorded in at least one of the clip-info file (*.clpi) and the stream file (*.m2ts). Also, the “stream_type” information for identifying stream types is recorded in at least one of the clip-info file (*.clpi) and the playlist file (*.mpls). Specifically, provided that the “stream_type” information is recorded in the playlist file (*.mpls), the “stream_type” information may be preferably recorded in a specific playitem (PlayItem). Also, the “GOP_structure_map” information must be recorded in the stream file (*.m2ts) including GOPs of the stream.

In association with the above-mentioned description, FIG. 6 exemplarily shows a specific clip contained in the file structure, and a specific case in which all GOPs (See FIG. 4B) composed of only the normal GOPs are recorded in the specific clip “01000.clpi” or “01000.m2ts”. Therefore, the first information for identifying individual GOPs (i.e., “GOP_type=00b” is recorded in a corresponding clip, and the second information for identifying all stream types (i.e., “stream_type=00b”) is recorded in a corresponding clip.

For another example, FIG. 6 exemplarily shows a specific clip contained in the file structure, and a specific case in which a stream (See FIG. 4C) formed by the combination of the normal GOPs and the long GOPs is recorded in the clip “02000.clpi” or “02000.m2ts”. Therefore, the first information for identifying individual GOPs (i.e., “GOP_type=00b” is recorded in a corresponding clip, and the second information for identifying all stream types (i.e., “stream_type=11b”) is recorded in a corresponding clip.

Individual stream files “01000.m2ts” and “02000.m2ts” may include “GOP_structure_map” information equipped with individual picture type information configured in the form of a table in a single GOP.

In association with the above-mentioned description, the aforementioned three information units (i.e., “GOP_type”, “stream_type”, and “GOP_structure_map”) may be included in a recording medium, or each of the aforementioned three information units may be independently included in the recording medium irrespective of the presence or absence of other information.

In other words, the present invention is characterized in that it constructs a recording medium using at least one of the aforementioned three information units, and employs at least one of the aforementioned information units when data of the recording medium is reproduced.

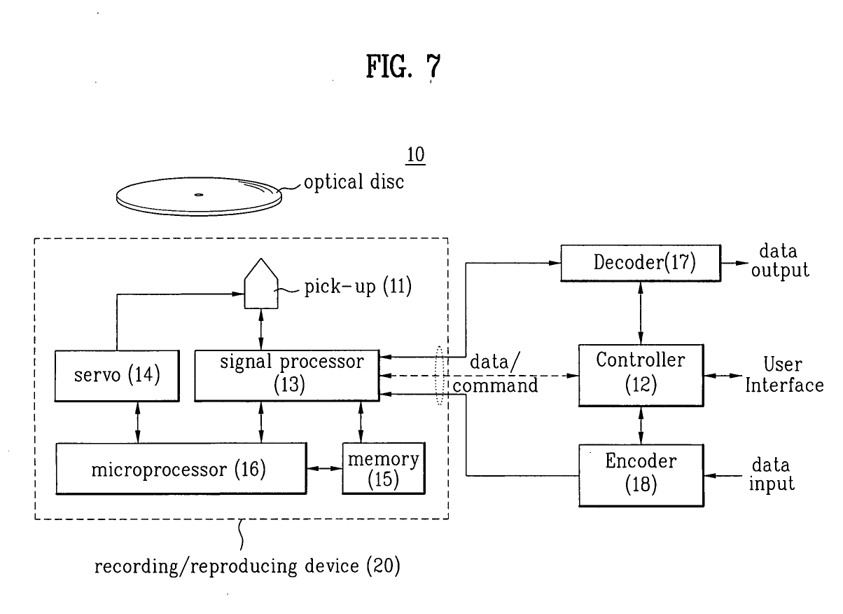

FIG. 7 is a block diagram illustrating an optical recording/reproducing device 10 according to the present invention. The optical recording/reproducing device 10 will hereinafter be described with reference to FIG. 7.

Referring to FIG. 7, the optical recording/reproducing device 10 includes a pickup unit 11, a servo unit 14, a signal processor 13, a memory 15, and a microprocessor 16 (also called a microcomputer).

The pickup unit 11 reads a data stream recorded in a stream area of an optical disc, reads management information including file information recorded in a reproduction management area, and records a specific signal in the optical disc. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the recovered or modulated result. The memory 15 stores information needed for reproducing data of the disc. The microprocessor 16 controls overall operations of the above-mentioned components contained in the optical recording/reproducing device 10.

In association with the above-mentioned operations, the combination of the above-mentioned components 11, 14, 13, 15, and 16 is also called a recording/reproducing unit 20, and the recording/reproducing unit 20 can be manufactured in the form of a single product.

A controller 12 controls all the constituent components shown in FIG. 7. Specifically, the controller 12 receives a reproduction command of a specific stream by interfacing with a user according to the present invention.

A decoder 17 finally decodes output data upon receiving a control signal from the controller 12, and transmits the decoded result to the user. In this case, the decoder decodes the output data using the aforementioned information, i.e., “GOP_type” information for identifying GOP types, “stream_type” information for identifying stream types, and “GOP_structure_type” information.

If the GOP is determined to be a long GOP, the long GOP includes several P- and B-pictures based on the I-picture, such that a more detailed decoding operation is required when the reference I-picture is decoded.

Specifically, if the optical recording/reproducing device 10 desires to reproduce data from a specific AP (e.g., AP3) in the long GOP equipped with APs (e.g., AP1˜AP5), at least one reference picture for reproducing the specific AP (i.e., AP3) picture must be pre-stored in the GOP, the “AP3” picture is restored using previous reference pictures stored in the memory during a presentation time of the AP3 picture, and the remaining pictures under the aforementioned AP3 are decoded and reproduced using the restored AP3 pictures.

An encoder 18 converts an input signal into a specific format signal (e.g., an MPEG2 transport stream) upon receiving a control signal from the controller 12, and transmits the converted result to the signal processor 13, such that it can record a desired signal in the optical disc.

In association with the above-mentioned description, a method for recording/reproducing data in/from an optical disc according to the present invention will hereinafter be described.

In the case of a method for reproducing data from the optical recording/reproducing (i.e., a presentation process) according to the present invention, if a recording medium in which a plurality of GOPs are recorded is loaded in the optical recording/reproducing device 10, the recording/reproducing unit 20 reads a variety of information units from the recording medium, for example, the “GOP_type” information for designating GOP types, the “stream_type” information for designating stream types, and the “GOP_structure_type” information. The decoder 17 reproduces individual GOPs recorded in the recording medium using the aforementioned read information.

In order to record a data stream composed of several GOPs in the recording medium according to a method for recording data in the optical recording/reproducing device, the encoder 18 classifies the data stream into at least one GOP type according to the aforementioned GOP lengths, encodes the stream composed of the classified GOPs, and transmits the encoded stream to the signal processor 13 contained in the recording/reproducing unit 20.

The recording/reproducing unit 20 simultaneously records a variety of information units in the recording medium, for example, the classified GOP information, the “GOP_type” information for designating GOP types, and the “GOP_structure_map” information.

As apparent from the above description, a recording medium, a method and apparatus for recording/reproducing data in/from the recording medium according to the present invention can more effectively record/reproduce the data stream in/from the recording medium, resulting in the creation of more convenient functions for a user of the above-mentioned recording medium.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A recording medium comprising:
a first area for recording a stream including a plurality of Groups Of Pictures (GOPs); and
a second area for recording GOP type information classified according to GOP lengths.

2. The recording medium according to claim 1, wherein the GOP type information is determined on the basis of a predicted presentation time of the GOPs.

3. The recording medium according to claim 2, wherein:
if the predicted presentation time of the GOP is equal to or less than 1 second, the GOP is determined to be a normal GOP; and
if the predicted presentation time of the GOP is longer than 1 second, the GOP is determined to be a long GOP.

4. The recording medium according to claim 1, wherein the GOP type information is determined by a total number (N) of all pictures contained in the GOP.

5. The recording medium according to claim 4, wherein:
if the total number of all pictures contained in the GOP is equal to or less than a specific number of 30, the GOP is determined to be a normal GOP; and
if the total number of all pictures contained in the GOP is higher than the specific number of 30, the GOP is determined to be a long GOP.

6. The recording medium according to claim 3, wherein the long GOP is classified into a first long GOP having at least one an Access pointer Picture (AP), and a second long GOP having no AP.

7. The recording medium according to claim 1, wherein the GOP type information for designating the GOP types is recorded in at least one of clip-info files

8. The recording medium according to claim 1, further comprising:
a third area for recording stream type information according to types of the GOPs contained in the stream.

9. The recording medium according to claim 8, wherein the stream type information for designating the stream types is recorded in at least one of a clip-info file and a playlist file.

10. A method for reproducing data of a recording medium in which a plurality of Groups Of Pictures (GOPs) are recorded, comprising the steps of:
a) reading first information for designating GOP types from the recording medium; and
b) reproducing individual GOPs contained in the recording medium using the read first information.

11. The method according to claim 10, further comprising the step of:
reading stream type information for designating stream types according to GOP types from the recording medium, and employing the read stream type information when individual GOPs contained in the recording medium are reproduced.

12. A method for recording data in a recording medium in which a data stream composed of a plurality of Groups Of Pictures (GOPs) is recorded, comprising the steps of:
a) classifying the GOPs recorded in the recording medium into at least one GOP type according to GOP lengths; and
b) recording the classified GOPs and GOP type information for designating GOP types in the recording medium.

13. The method according to claim 1, further comprising the step of:
further recording stream type information for designating stream types according to types of the GOPs contained in the stream in the recording medium.

14. An apparatus for reproducing data of a recording medium in which a plurality of Groups Of Pictures (GOPs) are recorded, comprising:
a recording/reproducing unit for reading Groups Of Pictures (GOPs) and GOP type information for designating types of the GOPs from the recording medium;
a decoder for reproducing individual GOPs contained in the recording medium using the read GOP type information; and
a controller for controlling operations of the recording/reproducing unit and the decoder.

15. The apparatus according to claim 14, wherein:
the recording/reproducing unit further reads stream type information for designating stream types according to GOP types from the recording medium, and
the decoder employs the read stream type information when individual GOPs contained in the recording medium are reproduced.

16. An apparatus for recording data in a recording medium in which a data stream composed of a plurality of Groups Of Pictures (GOPs) is recorded, comprising:
an encoder for classifying the recorded GOPs into at least one GOP type according to GOP lengths, and coding the stream composed of the classified GOPs;
a recording/reproducing unit for recording the stream composed of the classified GOPs and GOP type information capable of designating GOP types in the recording medium; and
a controller for controlling operations of the recording/reproducing unit and the encoder.

17. The apparatus according to claim 16, wherein the recording/reproducing unit further records stream type information for designating stream types according to types of the GOPs contained in the stream.

18. A recording medium comprising:
a first area for recording a stream including a plurality of Groups Of Pictures (GOPs); and
a second area for recording map information designating types of individual pictures contained in each GOP.

19. The recording medium according to claim 18, wherein the second area including the map information further records GOP type information classified according to the map information.

20. The recording medium according to claim 19, further comprising:
a third area for further recording stream type information for designating stream types according to types of the GOPs contained in the stream.

21. A method for recording data in a recording medium in which a plurality of Groups Of Pictures (GOPs) are recorded, comprising the steps of:
a) reading map information for designating types of individual pictures contained in each GOP from the recording medium; and
b) decoding individual pictures contained in the GOP using the read map information.

22. The method according to claim 21, further comprising the step of:
determining a decoding order of individual pictures contained in the GOP using the map information.
